(19) United States
(12) Patent Application Publication
(10) Pub. No.: US 2006/0168228 A1
(43) Pub. Date: Jul. 27, 2006

(54) System and method for maintaining data integrity in a cluster network

(75) Inventors: Bharath V. Vasudevan, Austin, TX (US); Nam V. Nguyen, Round Rock, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 11/018,316

(22) Filed: Dec. 21, 2004

(51) Int. Cl. G06F 15/177; G06F 15/173

(52) U.S. Cl. 709/226; 709/221

(57) ABSTRACT

A system and method for failure recovery and failure management in a cluster network is disclosed. Following a failure of a storage enclosure or a communication link failure between storage enclosures, each server node of the network determines whether the server node can access the drives of each logical unit owned by the server node. If the server node cannot access a set of drives of the logical that include an operational set of data, an alternate server node is queried to determine if the alternate server node can access the a set of drives of the logical unit that include an operational set of data.

### TECHNICAL FIELD

The present disclosure relates generally to computer networks, and, more particularly, to a system and method for maintaining data integrity in a cluster network.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

A server cluster is a group of independent servers that is managed as a single system. Compared with groupings of unmanaged servers, a server cluster is characterized by higher availability, manageability, and scalability. At a minimum, a server cluster includes two servers, which are sometimes referred to as nodes and which are connected to one another by a network or other communication links. A storage subsystem, including in some instances a shared storage subsystem, may be coupled to the cluster. A storage subsystem may include one or more storage enclosures, which may house a plurality of disk-based hard drives.

A server cluster network may include an architecture in which each of the server nodes of the network is directly connected to a single, adjacent storage enclosure and in which each server node is coupled to other storage enclosures in addition to the storage enclosure that is adjacent to the server node. In this configuration, the storage enclosures of the cluster reside between each of the server nodes of the cluster. Each storage enclosure includes an expansion port. To access a storage enclosure of the cluster—other than the storage enclosure of the cluster that is adjacent to the server—the server node must access the storage enclosure by passing the communication through the expansion ports of one or more of the storage enclosures, including the storage enclosure that is adjacent to the server node.

A RAID array may be formed of drives that are distributed across one or more storage enclosures. RAID storage involves the organization of multiple disks into an array of disks to obtain performance, capacity, and reliability advantages. In addition, the servers of the network may communicate with the storage subsystem according to the Serial Attached SCSI (SAS) communications protocol. Serial Attached SCSI is a storage network interface that is characterized by a serial, point-to-point architecture.

If a storage enclosure of the cluster were to fail, or if the communication links between the storage enclosures were to fail, drives of one or more of the storage enclosure would be inaccessible to the cluster nodes. In the case of a failed storage enclosure, for example, the drives of the failed storage enclosure and the drives of each storage enclosure that is distant from the server node would be inaccessible by the server node. In this example, the drives of the failed storage enclosure and the drives of any storage enclosure that is only accessible through the failed storage enclosure would not be visible to the affected server node. In addition, because any failed storage enclosure is necessarily located between two server nodes, each server node of the cluster may have a different view of the available drives of the storage enclosure. As a result of an enclosure failure, the drives of a RAID array may be separated from the server nodes of the storage network such that each server node of the cluster can access some, but not all, of the physical drives of the RAID array. In this circumstance, the server node that was the logical owner of the RAID array may or may not be able to access the RAID array.

### SUMMARY

In accordance with the present disclosure, a system and method for failure recovery and failure management in a cluster network is disclosed. Following a failure of a storage enclosure or a communication link failure between storage enclosures, each server node of the cluster determines whether the server node can access the drives of each logical unit owned by the server node. If the server node cannot access a set of drives of the logical unit that include an operational set of data, an alternate server node is queried to determine if the alternate server node can access a set of drives of the logical unit that include an operational set of data. A server node may not be able to access a complete set of drives of the logical unit if the drives of the logical unit reside on the failed enclosure or are inaccessible due to a broken storage link between storage enclosures. If the alternate server node can access the set of drives of the logical unit that include an operational set of data, ownership of the logical unit may be transferred to the alternate server node, depending on the storage methodology of the logical unit.

The system and method disclosed herein is technically advantageous because it provides a failure recovery mechanism in the event of a failure of an entire storage enclosure of a communication link failure between storage enclosures. Even though these types of failures may interrupt the ability of a first server node to communicate with all of the physical drives of a logical unit owned by that server node, the system and method disclosed herein provides a technique for accessing an operational set of data from the logical unit. In some instances, the accessible server nodes may comprise a complete set of drives. In other instances, the accessible server drives may comprise a set of drives from which a complete set of data could be derived, as in the case of a single inaccessible drive in a RAID level 5 array. Thus, because of the storage methodology of the drives of the logical array, the accessible drives of the logical unit may comprise an operational set of data, even if all of the drives of the logical unit are not accessible.

Another technical advantage of the failure recovery technique disclosed herein is that the techniques accounts for presence of a differing set of storage enclosures that may be visible to each server node of the network. When a storage enclosure fails, the failure presents each server node with a different set of operational storage enclosures and a different set of storage arrays. Thus, a portion of some drive arrays may be accessible to each server node; some drive arrays may be accessible by only one server node; and some drive arrays may not be accessible by either server node. Despite the differing views of each server node, the handling of ownership of the server nodes is managed such that the first server node having ownership retains ownership of the logical unit unless the first server cannot access the entire content of the storage array and the alternate or other server node can access the logical unit of the storage array.

Another technical advantage of the failure recovery technique disclosed herein is the ability of the recovery technique to preserve the data integrity and maintain the availability of the logical units of the computer network. When a set of drive is identified by a node as including an operation set of data, a designation is written to the drives to identify the drives as including the master copy of the data. The designation of the drives as including the master copy of the data prevents data discontinuities from occurring when the failed storage enclosure is restored and previously inaccessible drives, which may contain stale data, become accessible. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is an architectural diagram of a cluster network;

FIG. 2 is an architectural diagram of the cluster network that is missing a storage enclosure of the network;

FIG. 3 is a flow diagram of a method for preserving the data integrity of the network following a failure of a storage enclosure of a network;

FIG. 4 is a flow diagram of a method for identifying an incomplete logical unit to the alternate node of the network; and

FIG. 5 is an alternate version of an architectural diagram of the cluster network that is missing a storage enclosure of the network.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

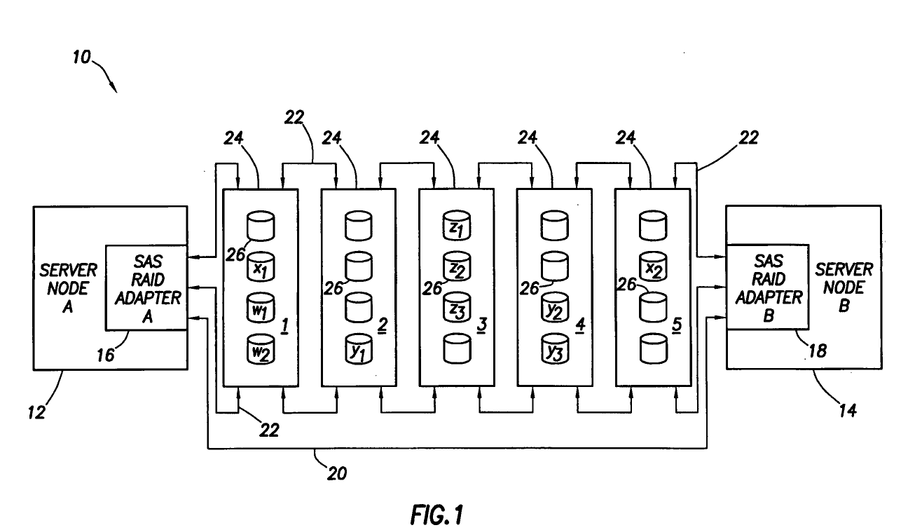

Shown in FIG. 1 is an architectural diagram of a cluster network, which is indicated generally at 10. Cluster network 10 includes two server nodes, which are identified as server node A at 12 and server node B at 14. Server node A includes SAS RAID adapter A, which is indicated at 16, and server node B includes SAS RAID adapter B, which is indicated at 18. Although only one RAID adapter is shown in each server node, it should be recognized that a server node may include multiple RAID adapters. The server nodes communicate with each other through a peer communication link 20. Configuration data is passed between the server nodes on peer communication link 20. Although peer communication link 20 is shown in FIG. 1 is a physical link, the peer communication link 20 of FIG. 1 can also be understood as a logical link between the server nodes, with the physical peer communication link aggregated within a communication path established by communications links 22 and storage enclosures 24.

Cluster network 10 includes five storage enclosures 24, each of which includes four drives 26. In the example of FIG. 1, each storage enclosure is identified by a numeral. From left to right, the enclosure are numbered 1 through 5, with storage enclosure 1 being coupled directly to the SAS RAID adapter of server node A and with storage enclosure 5 being coupled directly to the SAS RAID adapter of server node B. Each storage enclosure is coupled to at least one other storage enclosure. Storage enclosure 1 is coupled to server node A and storage enclosure 2; storage enclosure 5 is coupled to server node B and storage enclosure 4. Each of the interior storage enclosures—storage enclosure 2, storage enclosure 3, and storage enclosure 4—are coupled to two other storage enclosures. For a server node to access a storage enclosure that is not adjacent to the server node, the server node must pass the data access command through any intermediate storage enclosures. As an example, server node A can access a drive in storage enclosure 5 by passing the data access command through the expansion ports of each of storage enclosure 1-4 until the command reaches storage enclosure 5. Each storage enclosure is coupled to each other storage enclosure or to each server node, as applicable, by a pair of communication links 22. If one of the communication links 22 were to fail, communications could be passed to and from the storage enclosure by the opposite communications link in a manner that is transparent to the operating system and applications of the network. It should be recognized that the architecture of the network of FIG. 1, including the number of storage enclosures and drives of the network is depicted only as an example, and another network may differ in the number of storage enclosures and drives included in the network.

The storage enclosure of the network may include a plurality of RAID arrays, including RAID arrays in which the drives of the RAID array are distributed across multiple storage enclosures. In the example of FIG. 1, a RAID array W comprises two drives, identified as drives W₁ and W₂. RAID array W is a RAID Level 1 array. Each of the drives of RAID array W resides in storage enclosure 1. A RAID array X comprises two drives, one of which, identified as drive X₁, is housed in storage enclosure 1 and another of which, identified as drive X₂, is in storage enclosure 5. RAID array X comprises a RAID Level 1 array. A RAID array Y includes three drives. A drive Y₁ is in storage enclosure 2, and drives Y₂ and Y₃ are in storage enclosure 4. Raid array Y comprises a RAID Level 5 array. A RAID array Z includes three drives, labeled drives Z₁, Z₂, and Z₃. All of the drives of the RAID array Z are included in storage enclosure 3. Like RAID array Y, RAID array Z comprises a Level 5 array. Each drive of each RAID array is accessible by both server node A and server node B.

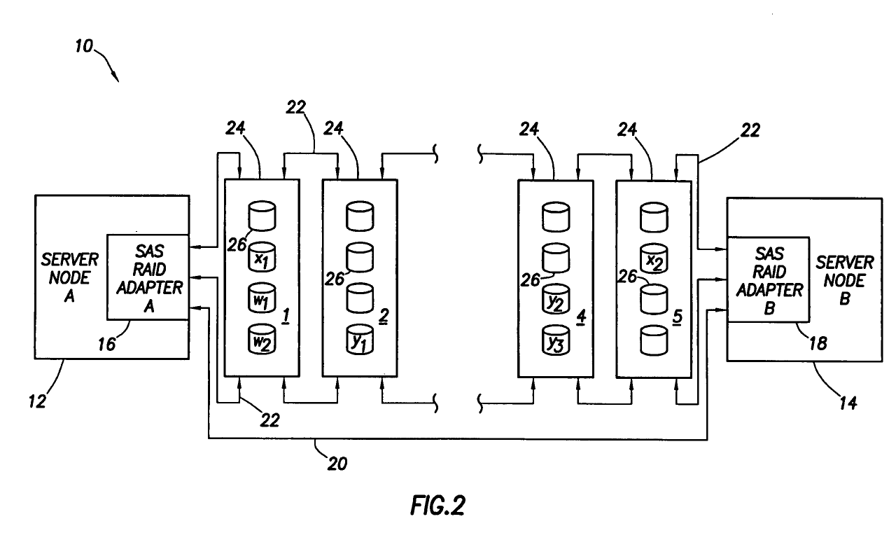

Shown in FIG. 2 is an architectural diagram of the cluster network. As compared with the architectural diagram of FIG. 1, storage enclosure 3 of FIG. 1 has failed and is not included in FIG. 2. As a result of the loss of storage enclosure 3, the links between storage enclosure 3 and each of storage enclosure 2 and storage enclosure 4 are disconnected. Because of the result of the failure of storage enclosure 3, server node A cannot access any drive in storage enclosure 3, storage enclosure 4, and storage enclosure 5. It can be said that the drives of storage enclosure 3, storage enclosure 4, and storage enclosure 5 are not visible to server node A. The only drives of the network that are visible to server node A are those drives in storage enclosure 1 and storage enclosure 2. Similarly, server node B cannot access any drive in storage enclosure 3, storage enclosure 2, and storage enclosure 1. The drives of storage enclosure 3, storage enclosure 2, and storage enclosure 1 are not visible to server node B. The drives of storage enclosure 4 and storage enclosure 5 are visible to server node B. Depending on the reporting capabilities of the network, both server node A and server node B will be notified when a failure occurs in the network that results in the disruption of access to one or more of the drives of the network. When such a failure is reported to the server nodes, each server node identifies the visible drives of those arrays that are owned by the server node.

In this example, storage enclosure 3 has failed. RAID array X is a two-drive Level 1 RAID array. Because of the failure of storage enclosure 3, only drive X₁ of RAID array X is accessible by and visible to server node A. Nonetheless, because RAID array X is a Level 1 RAID array, the entire content of the RAID array is available on drive X₁. Like server node A, server node B can access the entire content of RAID array X, as the entire content of the two-drive Level 1 RAID array is duplicated on each of the two drives, including drive X₂ in storage enclosure 5. In this example, because server node A was the logical owner of the RAID array X before the failure of storage enclosure 3, and because server node A can access the entire content of the RAID Array, server node A remains the logical owner of RAID array X immediately following the failure of storage enclosure 3. Server node A will remain the owner of RAID array X so long as server node A can verify that it can access the entire content of the RAID array. If server node A later fails, and if ownership of RAID array X is transferred to server node B, server node B must not accept ownership over RAID array X. In this circumstance, server node B must fail any new I/O operations to RAID array X and maintain the existing content of RAID array X even though server node B may have access to drive X₂, which in this example is a mirrored drive in a RAID Level 1 storage format that allows each mirrored drive to be seen by each node.

With respect to RAID array Y, drive Y₁ is the only drive of RAID array Y that is visible to server node A. RAID array Y is a three-drive Level 5 RAID array. Because server node A can access only one drive of the three-drive array, the entire content of RAID array Y is not accessible by and through server node A. Server node B, however, can access drives Y₂ and Y₃ of RAID array Y. Because two of the three drives of the distributed parity array are visible to server node B, the entire content of RAID array Y is accessible by server node B, as the content of drive Y₁ can be rebuilt from drives Y₂ and Y₃. Thus, while server node A cannot access the entire content of RAID array Y, server node B can access the entire content of RAID array Y. In this scenario, ownership of RAID array Y could be passed from server node A, which cannot access the entire content of the array, to server node B, which can access the entire content of the array. With respect to RAID array W, assuming that RAID array W is logically owned by server node A, the loss of the storage enclosure does not affect access to RAID array W, as all of the drives of RAID array W are still accessible by server node A. If it were the case that the drives of RAID array W were logically owned by server node B, server node B could not access any of the drives of RAID array W, and ownership of RAID array W could be passed to server node A, which does have access to the drives of RAID array W.

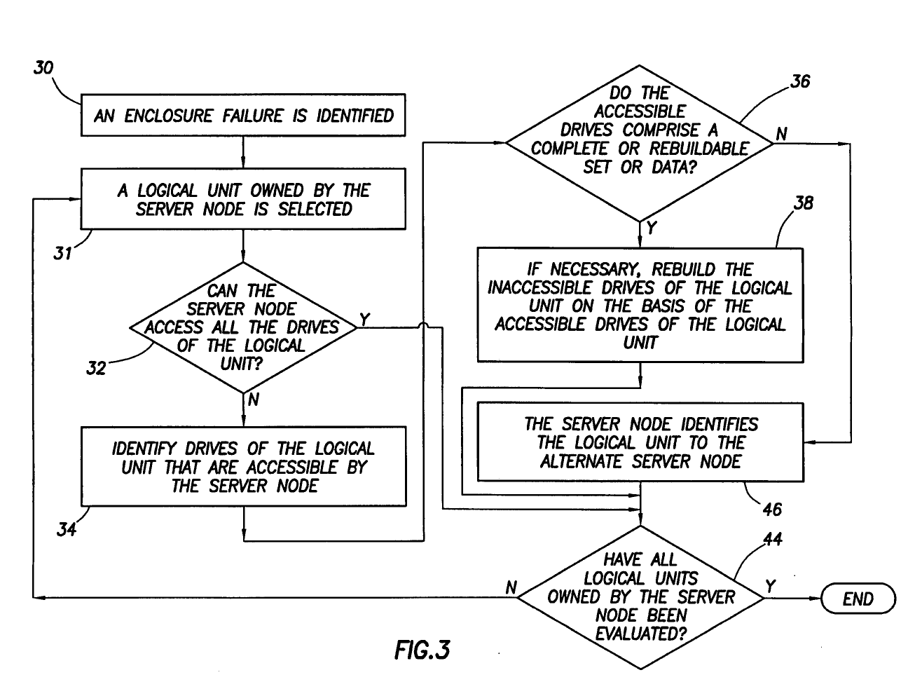

Shown in FIG. 3 is a flow diagram of a series of method steps for preserving the data integrity of the network following a failure of a storage enclosure of a network. The steps of FIG. 3 are performed with reference to each server node of the network. At step 30, the failure in the operation of an enclosure is identified by or reported to a server node. The failure that is referenced in step 30 may comprise any failure that prevents access to the drives of the effected enclosure. Examples include the failure of the entire storage enclosure or the failure of both communication links to the storage enclosure. At step 31, a logical unit owned by the server node is selected. At step 32, it is determined, for a logical unit owned by the server node, whether the server node can access each drive of the logical unit. If all drives of the selected logical unit are accessible by the server node, the flow diagram continues at step 44, where it is determined if all logical units owned by the server node have been evaluated. If all logical units, owned by the server node have been evaluated, the flow diagram ends. If all logical units owned by the flow diagram have not been evaluated, the flow diagram continues with the selection of another logical unit for evaluation at step 31.

If it is determined at step 32 that at least one drive of a logical unit owned by the server node cannot be accessed, the accessible drives of the logical unit are identified by the server node at step 34. It is next determined at step 36 if the accessible drives of the logical unit comprise a complete set of data of the logical unit or otherwise comprise a set of data from which a complete set of data could be derived. If the accessible drives of the logical unit comprise a complete set of data of the logical unit or otherwise comprise a set of data from which a complete set of data could be derived, the drives of the logical units are defined as including an operational set of data. As an example, if the server node is only able to access one drive of a two-drive Level 1 RAID array, the server node nevertheless has access to a complete set of data, as the content of each drive is mirrored on the other drive of the array. As another example, if the server node is only able to access two drives of a three-drive Level 5 RAID array, the server node nevertheless has access to a complete set of data, as the content of the missing drive can be derived from the data and parity information on the two accessible drives. As a final example, if two drives of a three-drive Level 5 RAID array are inaccessible, the accessible drives of the RAID array do not form a complete set of data or a set of data from which a complete set of data could be derived. Applying this standard to the example of FIGS. 1 and 2, server node A would have access to a complete set of RAID array X, as this array is a two-drive Level 1 RAID array and one of the two drives is accessible to server node A. With respect to RAID array Y, node A of FIGS. 1 and 2 would not have access to a set of data from which a complete set of data could be derived. RAID array Y is a three-drive Level 5 RAID array, and server node A has access to only one of the three drives.

If it is determined at step 36 that the server node that owns the logical unit does have access to the drives of the logical unit that comprise a complete set of data or a set of data from which a complete set of data could be derived, any missing drives of the logical unit are rebuilt at step 38 on one of the active storage enclosures. In the example of FIGS. 1 and 2, drive X₂ could be rebuilt in storage enclosure 1 or storage enclosure 2 of the storage network. Rebuilding the drive provides for some measure of fault tolerance in the array in the event that drive X₁ fails or rebuild drive X₂ later fails. The flow diagram continues at step 44, where it is determined if all logical units owned by the server node have been evaluated. If all logical units, owned by the server node have been evaluated, the flow diagram ends. If all logical units owned by the flow diagram have not been evaluated, the flow diagram continues with the selection of another logical unit for evaluation at step 31.

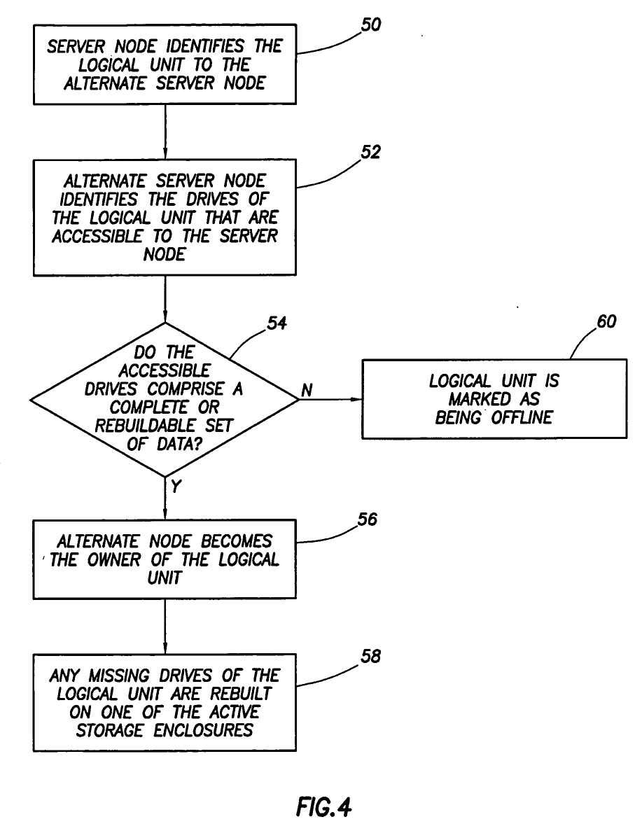

If it is determined at step 36 that the server node that owns the logical unit does not have access to drives of the logical unit that comprise a complete set of data or a set of data from which a complete set of data could be derived, the server node identifies the logical unit to the alternate node at step 46. The alternate node does not have ownership of the logical unit. The method used by the alternate unit to evaluate the data integrity of the logical unit relative to the ability of the alternate unit to access drives of the logical unit is described in FIG. 4. Following step 46, the flow diagram continues at step 44, where it is determined if all logical units owned by the server node have been evaluated. If all logical units, owned by the server node have been evaluated, the flow diagram ends. If all logical units owned by the flow diagram have not been evaluated, the flow diagram continues with the selection of another logical unit for evaluation at step 32.

Shown in FIG. 4 is a flow diagram of a series of method steps for identifying an incomplete logical unit to the alternate node of the network. The steps of FIG. 4 comprise step 46 of FIG. 3 and are performed as a result of the determination at step 36 in FIG. 3 that a logical unit owned by a server node is incomplete in that the entire content of the logical unit is not present in and cannot be derived from the drives of the logical unit that are visible to the node that owns the logical unit. Following this determination, it is determined if the alternate server node can access drives of the logical unit that comprise the entire content of the logical unit. At step 50 of FIG. 4, the server node that owns the logical unit identifies the logical unit to the alternate server node. In the example of FIGS. 1 and 2, logical unit Y is owned by server node A and this logical unit is incomplete with respect to server node A. At step 52, the alternate server node identifies the drives of the logical unit that are accessible to the alternate server node. In the example of FIGS. 1 and 2, drives Y2 and Y3 are accessible to server node B, which in this example is the alternate server node.

At step 54 it is determined if the drives of the logical unit that are accessible by the alternate node comprise a complete set of data of the logical unit or otherwise comprise a set of data from which a complete set of data could be derived. With respect to the example of FIGS. 1 and 2, server node B can access drives Y₂ and Y₃ of logical unit Y. Because logical unit Y is a Level 5 RAID array, a complete set of the data of the logical unit can be derived from drives Y₂ and Y₃. Thus, with respect to logical unit Y, server node B has access to drives from which a complete set of the data comprising logical unit Y can be derived.

If it is determined at step 54 that the drives of the logical unit that are accessible by the alternate node comprise a complete set of data of the logical unit or otherwise comprise a set of data from which a complete set of data could be derived, the flow diagram continues with step 56, where the alternate node becomes the owner of the logical unit. At step 58, because the original owner of the logical unit could not access a complete set of data comprising the logical unit, the alternate node, which can access a complete set of data comprising the logical unit, becomes the owner of the logical unit. At step 58, any missing drives of the logical unit are rebuilt on one of the active storage enclosures. In the example of FIGS. 1 and 2, drive Y₁ would be rebuilt on a drive of storage enclosure 4 or storage enclosure 5.

If it is determined at step 54 that the drives of the logical unit that are accessible by the alternate node do not comprise a complete set of data of the logical unit or do not otherwise comprise a set of data from which a complete set of data could be derived, the flow diagram continues with step 60, where the logical unit is marked as having failed and communication with any of the drives comprising the logical unit is discontinued. Following the restoration of the failed storage enclosure, the original configuration of the drives of each logical unit can be restored. In doing so, the master copy of the data can be used to update drives that were not included in the logical unit during the period that the failed storage enclosure was not operational. In the example of FIGS. 1 and 2, drive Y₁ can be returned to the logical unit, and the data from drives identified as having a master copy of the data of the logical unit, drives Y₂ and Y₃, can be migrated to drive Y₁.

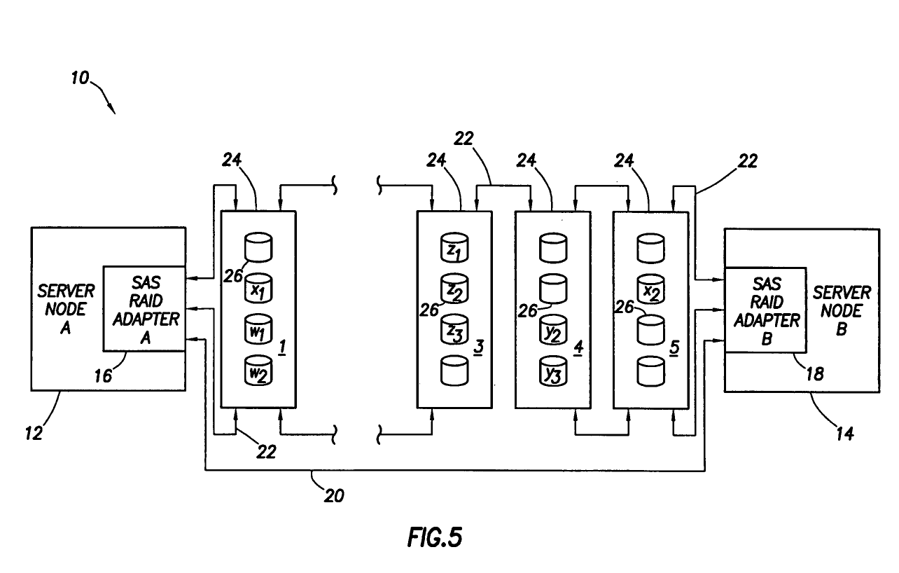

As an additional example, FIG. 5 is an architectural diagram of a cluster network. As compared with the architectural diagram of FIG. 1, storage enclosure 2 of FIG. 1 has failed and is not included in FIG. 5. Initially, each of the RAID arrays of FIG. 5 is owned by server node A. In this example, following the failure of storage enclosure 2, the only drive that is visible to server node A is drive X₁. Because drive X₁ is a drive of a two-node RAID Level 1 array, and because the entire content of the array is present in drive X₁, server node A maintains ownership of RAID array X. None of the drives of RAID array Y are visible to server node A. Drives Y2 and Y3 are visible to server node B. Thus, because the entire content of RAID array Y is not accessible through server node A, and because the entire content of RAID array Y can be derived from the drives of RAID array Y that are accessible through server node B, the ownership of RAID array Y is passed from server node A to server node B. Finally, none of the drives of RAID array Z is visible to server node A, but all of the drives of RAID array Z are visible to server node B. Thus, because server node A cannot access the entire content of RAID array Z, and because server node B can access the entire content of RAID array Z, ownership of RAID array Z is passed from server node A to server node B. The loss of storage enclosure 2, as compared with the loss of storage enclosure 3, does not affect the ability of either server node to access RAID array W.

It should be recognized that the technique disclosed herein is sufficiently robust that, in the event of a failure of a storage enclosure, an alternate server node may not attempt to access the resources of a logical unit until it is authorized or instructed to do so by the server node that owns the logical unit. It should also be recognized that, if there is a failure in a first storage enclosure, it may be necessary to prevent an attempt to recover from the failure in a second enclosure failure. Thus, in the case of a two-drive mirrored array, for example, if a storage enclosure were to fail, and if both drives remain operational after the failure, it would be possible for the array to remain operational even though the node owning the logical unit is able to access only the first drive of the array. Updates to the first drive, however, would not be reflected in the second drive. As such, if the node owning the logical unit were to later fail, the alternate node should be prevented from accessing the second drive, as this drive will not include an updated set of data

In sum, the present disclosure concerns a technique in which each server node attempts, in the event of a storage enclosure failure, to catalog or identify those drives that are visible to the server node. For each array owned by the server node, if the server can access (a) drives having the entire content of the array or (b) drives from which the entire content of the array can be derived, the server node retains ownership of the array. If the server node that owns a certain array cannot access drives having the entire content of the array or drives from which the entire content of the array can be derived, and if the alternate server node can access (a) drives having the entire content of the array or (b) drives from which the entire content of the array can be derived, ownership of the array is passed to the alternate server node. In addition, in the case of RAID 1 and RAID 10 arrays, an ownership message can be sent to the alternate server node to notify the alternate server node that it should not write to drives of the RAID array in the event of a failure of the first server node. Preventing the alternate server node from writing to the drives of the RAID array will preserve the data integrity of the RAID array in the event of a failure in the server node that owns the RAID array following a storage enclosure failure.

The failure recovery methodology described herein provides a mechanism for preserving the data integrity of logical units following the failure of a storage enclosure of the network. The logical units owned by each server node are identified. If a server node can access a complete set of data on a logical unit that is owned by the server node, the server nodes retains ownership of the server node and continues to read and write data to the logical unit. If the server node that owns a logical unit cannot access a complete set of data on the logical unit, and if an alternate server node can access a complete set of data on the logical unit, the ownership of the logical unit is transferred to the alternate server node, which coordinates reads and writes to the logical unit. When the failed storage enclosure is returned to operational status, the master copy of the data of each logical unit is identified from a designation written to each drive that includes a master copy of the data of the logical unit. The data of the master copy can be distributed to a drive that was not included in the logical unit during the period that the failed storage enclosure was not operational.

Although the present disclosure has been described in detail, it should be understood that various changes, substitutions, and alterations can be made hereto without departing from the spirit and the scope of the invention as defined by the appended claims.

What is claimed is:

1. A method for failure recovery in a network, comprising the steps of:
identifying a failed storage enclosure of the network;
identifying a logical storage unit owned by a first server node of the network;
identifying the storage drives of the logical unit that are accessible by the first server node;
determining whether the storage drives of the logical unit that are accessible by the first server node comprise an operational set of data;
if the storage drives accessible by the first storage node do not comprise an operational set of data,
identifying the logical unit to an alternate server node;
determining whether the alternate server node can access a set of storage drives of the logical unit that include an operational set of data; and
transferring ownership of the logical unit to the alternate server node if the alternate server node can access a set of storage drives that include an operational set of data of the logical unit.

2. The method for failure recovery in a network of claim 1, wherein the storage drives of the logical unit that are accessible by the first server node comprise an operational set of data if (a) the accessible drives comprise the complete set of drives of the logical unit or (b) the accessible drives comprise a set of drives from which a complete set of drives of the logical unit could be derived.

3. The method for failure recovery in a network of claim 2, further comprising the step of rebuilding a drive of the logical unit if (a) the storage drives of the logical unit that are accessible by the first server node comprise an operational set of data, and (b) the accessible drives of the logical unit comprise a set of drives from which a complete set of drives of the logical unit could be derived.

4. The method for failure recovery in a network of claim 1, wherein the storage drives of the logical unit that are accessible by the first server node comprise an operational set of data if (a) the accessible drives of the logical unit comprise the complete set of drives of the logical unit or (b) the accessible drives of the logical unit comprise a set of drives from which a complete set of drives of the logical unit could be derived.

5. The method for failure recovery in a network of claim 4, further comprising the step of rebuilding a drive of the logical unit if (a) the storage drives of the logical unit that are accessible by the first server node comprise an operational set of data, and (b) the accessible drives of the logical unit comprise a set of drives from which a complete set of drives of the logical unit could be derived.

6. The method for failure recovery in a network of claim 1, wherein the data of the logical unit is stored according to a RAID storage methodology.

7. The method for failure recovery in a network of claim 1, further comprising the step of, if the storage drives of the logical unit that are accessible by the first server node comprise an operational set of data, writing a confirmatory designation to the drives of the logical unit that are accessible by the first server node to designate the drives as including a master copy of the data of the logical unit.

8. The method for failure recovery in a network of claim 1, further comprising the step of, if the storage drives that are accessible by the first server node do not comprise an operational set of data and if the storage drives that are accessible by the alternate server node do comprise an operational set of data, writing a confirmatory designation to the storage drives that are accessible by the alternate server node to designate the drives as including a master copy of the data of the logical unit.

9. A network, comprising:
a first server node;
a second server node;
a first storage enclosure coupled to the first server node, wherein the first storage enclosure includes a plurality of storage drives;
a second storage enclosure coupled to the second server node, wherein the second storage enclosure includes a plurality of storage drives;
an intermediate storage enclosure positioned communicatively between the first storage enclosure and the second storage enclosure such that the intermediate storage enclosure is communicatively coupled to the first storage enclosure and the second storage enclosure, wherein the intermediate storage enclosure includes a plurality of storage drives and wherein each storage drive is accessible to the first server node and the second server node;
wherein the each of the server nodes have logical ownership over one or more logical units comprised of storage drives of the storage enclosures;
wherein, in the event of a failure of a storage enclosure, each server node is operable to,
evaluate, for each logical unit owned by each server node, whether the server node has access to storage drives of the logical unit that comprise an operational set of data; and
for each logical unit owned by the server node, transferring ownership of the logical unit to the other server node if the server node does not have access to storage drives of the logical unit that comprise an operational set of data and if the other server node does have access to storage drives of the logical unit that comprise an operational set of data.

10. The network of claim 9, wherein the each logical unit comprises an array of drives to which data is saved according to a RAID storage methodology.

11. The network of claim 9, wherein a set of storage drives accessible by a server node comprise an operational set of data if (a) the accessible drives comprise the complete set of drives of the logical unit or (b) the accessible drives comprise a set of drives from which a complete set of drives of the logical unit could be derived.

12. The network of claim 11, wherein each server node is further operable to rebuild a drive of the logical unit if (a) the storage drives accessible by the server node comprise an operational set of data, and (b) the accessible drives comprise a set of drives from which a complete set of drives of the logical unit could be derived.

13. The network of claim 12, wherein each server node is further operable to write a confirmatory designation to each drive of a logical unit following a determination that the server node has access to storage drives of the logical unit that comprise an operational set of data.

14. The network of claim 13, wherein each server node is further operable to mark a logical unit as being offline if neither the server node nor the opposite server node is able to access a set of storage drives of the logical unit that comprise an operational set of data.

15. A method for failure recovery in a network, wherein the network comprises first and second server nodes communicatively coupled to a set of multiple storage enclosures, wherein each of the storage enclosures includes multiple storage drives logically organized into logical storage units, comprising the steps of:
identifying a failed storage enclosure of the network;
identifying a logical storage unit owned by the first server node of the network;
identifying the storage drives of the logical unit that are accessible by the first server node;
determining whether the storage drives of the logical unit that are accessible by the first server node comprise an operational set of data;
if the storage drives accessible by the first storage node do not comprise an operational set of data,
identifying the logical unit to the second server node;
determining whether the second server node can access a set of storage drives of the logical unit that include an operational set of data; and
transferring ownership of the logical unit to the second server node if the second server node can access a set of storage drives of the logical unit that include an operational set of data.

16. The method for failure recovery in a network of claim 15, further comprising the step of marking the logical unit as being offline if the storage drives of the logical unit accessible by the first server node and the second server node do not comprise an operational set of data.

17. The method for failure recovery in a network of claim 15, further comprising the step of writing a designation to the drives of the logical unit that are accessible by the first server node to identify the drives as including a master copy of the data of the logical unit if it is determined that the storage drives of the logical unit that are accessible by the first storage node comprise an operational set of data.

18. The method for failure recovery in a network of claim 15, further comprising the step of writing a designation to the drives of the logical unit that are accessible by the second server node to identify the drives as including a master copy of the data of the logical unit if it is determined that (a) the storage drives of the logical unit that are accessible by the first storage node do not comprise an operational set of data, and (b) the storage drives of the logical unit that are accessible by the second storage node comprise an operational set of data.

19. The method for failure recovery in a network of claim 15, wherein a set of accessible storage drives of a logical unit comprise an operational set of data if (a) the accessible drives of the logical unit comprise the complete set of drives of the logical unit or (b) the accessible drives of the logical unit comprise a set of drives from which a complete set of drives of the logical unit could be derived.

20. The method for failure recovery in a network of claim 15, wherein the data of the storage drives of each logical unit is stored according to a RAID storage methodology.
